(19) United States
(12) Patent Application Publication
(10) Pub. No.: US 2008/0155839 A1
(43) Pub. Date: Jul. 3, 2008

(54) Cutting tools made of an in situ composite of bulk-solidifying amorphous alloy

(76) Inventor: Mark C. Anderson, Minnetonka, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/004,658

(22) Filed: Dec. 21, 2007

Related U.S. Application Data
(60) Provisional application No. 60/876,396, filed on Dec. 21, 2006.

(51) Int. Cl. B26B 9/00; B26B 9/02; B25G 1/00

(52) U.S. Cl. 30/350; 30/355; 30/340

(57) ABSTRACT

A cutting tool comprising: a blade portion having a cutting edge and a body portion; wherein the blade portion is made at least in part of a composite material comprising an amorphous metal alloy forming a substantially continuous matrix, and a second ductile metal phase embedded in the matrix and formed in situ in the matrix by crystallization from a molten alloy.

### PRIORITY

The present non-provisional patent application claims benefit from U.S. Provisional Patent Application having Ser. No. 60/876,396, filed on Dec. 21, 2006, by Anderson, and titled CUTTING TOOLS MADE OF AN IN SITU COMPOSITE OF BULK-SOLIDIFYING AMORPHOUS ALLOY, wherein the entirety of said provisional patent application is incorporated herein by reference.

### FIELD OF THE INVENTION

The present invention relates generally to cutting tools, and more particularly relates to cutting tools made at least in part of an in situ composite of bulk-solidifying amorphous alloy.

### BACKGROUND OF THE INVENTION

Toolmakers have long sought to improve durability and functionality of cutting tools by trying different materials. Early progress included work-hardening of metal and adding steel edges to iron implements. In general, an ideal cutting tool should combine abrasion-resistance (hardness) with shock resistance (toughness).

Cutting tools are currently produced using a variety of different materials. The materials being used can have significant disadvantages. For example, in particular, knife blades may be produced from hard materials, such as carbides, which produce sharp and effective cutting edges. However, such a material has a high manufacturing cost. In addition, cutting edges of blades made from such a material are extremely fragile due to the intrinsic low toughness of the material. Knife blades can also be made of conventional metals, such as stainless steel, which have a low cost. However, the cutting performance of these blades does not match that of the more expensive, hard materials, like carbides.

Some cutting tools made of conventional materials are cut from sheet metal stock (otherwise known as “bar stock”). After being cut, edges of the blades are ground and sharpened. In addition, serrations may be added to the edges. Other cutting tools may attach a cutting edge band of one material, which may be tough, for example, to a metal base made of another material that may be less tough but highly wear resistant, for example.

More recently, cutting tools, such as knife blades, have been made of amorphous alloys. Amorphous alloys provide blades having high hardness, ductility, elastic limit and corrosion resistance at a relatively low cost. The drawback to using amorphous alloys has been that the type, shape, and size of blades that can be produced are limited by the processes required to produce the amorphous alloys. Generally, the amorphous alloys are manufactured in strips or added to the surface to conventional blades by being deposited as a coating.

Thus, there is a continuing need for new and improved cutting tools, and processes with which to make them. In particular, it is desirable for such cutting tools to be formed of one material, with the material having both properties of hardness and toughness. It is also desirable to have the cutting tool be a unitary piece. In addition, it is desirable for such cutting tools to be made in as few steps as possible. In particular, it is desirable to injection mold such cutting tools.

### SUMMARY OF THE INVENTION

The present invention relates to cutting tools made at least in part from an in situ composite of bulk-solidifying amorphous alloy. The in situ composite of bulk-solidifying amorphous alloy comprises a ductile crystalline phase distributed in a fully amorphous matrix. The composite is formed in situ by cooling from a fully molten alloy, wherein the ductile crystalline phase precipitates first upon cooling and then the remaining molten alloy freezes into an amorphous matrix. The ductile crystalline phase is preferably a primary crystalline phase of the main constituent element of the alloy and in dendritic form.

Cutting tools made from an in situ composite of bulk-solidifying amorphous alloy have many advantages. Firstly, as a consequence of the high yield strength, superior elastic limit, high corrosion resistance, high hardness, superior strength-to-weight ratio, high wear-resistance, and other characteristics associated with amorphous metals, using the material for cutting tools is advantageous. Cutting tools made of in situ composite of bulk-solidifying amorphous alloy possess significantly greater strength, durability, impact resistance and “memory” than many conventional cutting tools. These cutting tools are stronger and less likely to break or deflect to an undue degree during use or storage. Because of the superior strength of the material, cutting tools made from the material can also be fabricated with finer and/or smaller structures. Also, even if a load were severe enough to cause significant deflection, the cutting tools made of the material benefit from deformation “memory” (i.e., ability to substantially return to its original position). Whereas a conventional cutting tool will tend to permanently deform and risk loss of function, the cutting tools made from the material will tend to return substantially to the original configuration when the deforming force is removed. Such cutting tools thus have a much greater tendency to retain their utility. In such cutting tools, the material is corrosion resistant, and, therefore, cutting tools including the material have a much longer service life than a cutting tool made from a conventional metal formulation.

In situ composite of bulk-solidifying amorphous alloy may have a lower density than many conventional metal formulations. Cutting tools including such material can be dramatically lighter than their conventional counterparts. Such lighter-weight cutting tools are easier to handle while cutting food and other items. In addition, in situ composite of bulk-solidifying amorphous alloy may have low coefficients of friction, both wet and dry. Consequently, it has been found that the ability of cutting tools made of such material to cut food and other items is improved.

Another advantage of cutting tools made from such material is that that they can be fabricated, if desired, using casting and molding processes in one step and, if desired, in one unitary piece. The material is compatible with such fabrication processes and the resultant cutting tools are quite strong and durable. Additionally, cutting edges of such cutting tools may be molded to be sharp and to have serrations, which eliminates the need to sharpen a blade or add serrations later. Eliminating the sharpening or serration step saves time in the manufacturing process and also saves material, which is not wasted by being ground or cut off the blade.

The present invention relates to a cutting tool. One embodiment of the cutting tool comprises: a blade portion having a cutting edge; and a body portion; wherein at least one of the blade portion or the body portion are formed at least in part of a composite material comprising: an amorphous metal alloy forming a substantially continuous matrix; and a second ductile metal phase embedded in the matrix and formed in situ in the matrix by crystallization from a molten alloy. The second phase may be formed from a molten alloy having an original composition in the range of from 52 to 68 atomic percent zirconium, 3 to 17 percent titanium, 2.5 to 8.5 atomic percent copper, 2 to 7 atomic percent nickel, 5 to 15 percent beryllium, and 3 to 20 percent niobium. The second phase may be sufficiently spaced apart for inducing a uniform distribution of shear bands throughout a deformed volume of the composite, the shear bands involving at least four volume percent of the composite before failure in strain and traversing both the amorphous metal alloy matrix and the second phase. The second phase may be in the form of dendrites. The second phase may have a modulus of elasticity less than the modulus of elasticity of the amorphous metal alloy. The ductile metal particles of the second phase may be sufficiently spaced apart for inducing a uniform distribution of shear bands traversing both the amorphous phase and the second phase and having a width of each shear band in the range of from 100 to 500 nanometers. The second phase may have an interface in chemical equilibrium with the amorphous metal alloy matrix. A stress level for transformation induced plasticity of the ductile metal particles may be at or below a shear strength of the amorphous metal alloy matrix. The second phase comprises particles may have a spacing between adjacent particles in the range of 0.1 to 20 micrometers. The second phase may comprise particles having a particle size in the range of from 0.1 to 15 micrometers. The second phase may comprise in the range of from 15 to 35 volume percent of the composite. The cutting tool may further comprise a handle mounted onto the body portion. The handle may be formed from a material selected from the group consisting of: a plastic, a metal and wood. The cutting edge may be serrated. The cutting edge may have a radius of curvature of about 150 Angstroms or less. The composite material may have a thickness of at least 1 mm. The second phase may comprise a ductile metal alloy that has an interface in chemical equilibrium with the amorphous metal matrix, and the composite may be free of a third phase. The composite may have a stress induced martensitic transformation.

A second embodiment of the cutting tool of the present invention comprises: a blade portion having a cutting edge; and a body portion; wherein at least one of the blade portion or the body portion are formed at least in part of a composite material comprising: an amorphous metal alloy forming a substantially continuous matrix; a second ductile metal phase in the form of dendrites is embedded in the matrix and formed in situ in the matrix by crystallization from a molten alloy; and wherein the dendrites have lengths of about 15 to 150 micrometers, the dendrites comprise secondary arms having widths of about 4 to 6 micrometers, and the secondary arms are spaced apart about 6 to 8 micrometers.

A third embodiment of the present invention is a cutting tool comprising: a blade portion having a cutting edge; and a body portion; wherein at least one of the blade portion or the body portion are formed at least in part of a composite material comprising: an amorphous metal alloy forming a substantially continuous matrix; and a second ductile metal phase in the form of particles is embedded in the matrix and formed in situ in the matrix by crystallization from a molten alloy; and wherein the particles have a particle size in the range of from 0.1 to 15 micrometers, spacing between adjacent particles in the range of 0.1 to 20 micrometers, the particles are in the range of from about 5 to 50 volume percent of the composite, the particles are sufficiently spaced apart for inducing a uniform distribution of shear bands traversing both the amorphous phase and the second phase and having a width of each shear band in the range of from 100 to 500 nanometers.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a partial cross-sectional side view of a cutting tool in accordance with the present invention;

FIG. 2 is a schematic binary phase diagram;

FIG. 3 is a pseudo-binary phase diagram of an exemplary alloy system for forming a composite by chemical partitioning;

FIG. 4 is a phase diagram of a Zr—Ti—Cu—Ni—Be alloy system;

FIG. 5 is an exemplary SEM photomicrograph of an in situ composite formed by chemical partitioning;

FIG. 6 is an exemplary photomicrograph of such a composite after straining; and

FIG. 7 is a compressive stress-strain curve for such a composite.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The present invention is directed to cutting tools wherein at least a portion of the device is formed of an amorphous metal alloy forming a substantially continuous matrix with a second ductile metal phase embedded in the matrix and formed in situ in the matrix by crystallization from a molten alloy. One example of such a bulk-solidifying amorphous alloy, as it may be called, is a ductile metal reinforced bulk metallic glass matrix composite.

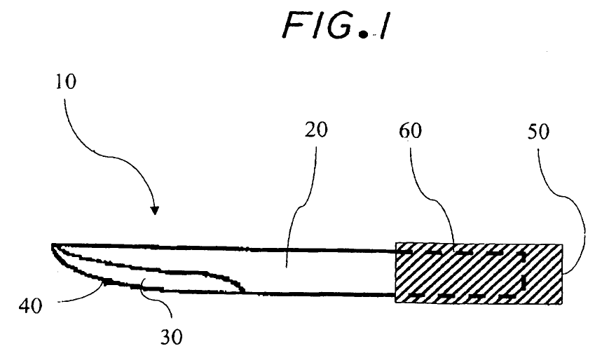

For purposes of illustration, FIG. 1 shows a representative cutting tool 10. In general, the cutting tool 10 has a body 20 and a blade 30. In such cutting tools, the blade 30 is defined as that portion of the cutting tool which tapers to a terminating cutting edge 40, while the body 20 of the cutting tool is defined as the structure that transfers an applied load from the cutting tool driving force, to the cutting edge 40 of the blade. In addition, as shown in FIG. 1, cutting tool 10 may include an optional handle or grip 50 which serves as a stable interface between the cutting tool user and the cutting tool. In such a case, the portion of the body 20 to which the handle is attached is called the shank 60. At least one of the blade portion 30 and the body portion 20 are formed at least in part of an in situ composite of bulk-solidifying amorphous alloy. In situ composites of bulk-solidifying amorphous alloy are discussed in detail below.

In one embodiment of the present invention, at least the blade 30 of the cutting tool 10 is at least in part formed from an in situ composite of bulk-solidifying amorphous alloy as described below. In such an embodiment, although any size and shape of blade 30 may be manufactured, it is desirable that the cutting edge 40 of the cutting tool 10 have a radius of curvature as small as possible for a high performing operation. Preferably, the cutting tool 10 comprises a blade 30 having a cutting edge 40 with a radius of curvature of about 150 Angstroms or less.

In addition to the blade 30 of the cutting tool 10 being at least in part formed from an in situ composite of bulk-solidifying amorphous alloy, it should be understood that an in situ composite of bulk-solidifying amorphous alloy can also be used as the supporting portion of the blades such as the body 20 of the cutting tool. Such construction is desirable because in cutting tools where the sharp edge has a different microstructure (for higher hardness) than the microstructure of the body support (which provide higher toughness though at substantially lower hardness), once the sharp edge becomes dull, and/or re-sharpened a few times, the blade material is consumed and the cutting tool must be discarded. In addition, using a single material for both the body 20 and blade 30 reduces the likelihood of the different materials suffering corrosion, such as through galvanic action. Finally, since the body 20 and blade 30 of the cutting tool 10 are one piece, no additional structure is needed to attach the blade 30 to the body 20, so there is a more solid and precise transfer of force to the blade 30, and, therefore, a more solid and precise feel for the user. Accordingly, in one embodiment the invention is directed to a cutting tool 10 in which both the blade 30 and the support body 20 is made of an in situ composite of bulk-solidifying amorphous alloy.

In those cases in which a handle 50 is formed on the body 20 of the cutting tool 10, the handle 50 and body 20 may be constructed as a single piece made of an in situ composite of bulk-solidifying amorphous alloy. Alternatively, the handle 50 may be formed of other material and mounted to the body 20 of the cutting tool 10. The handle may be formed from a material selected from the group consisting of: a plastic, a metal and wood, for examples.

The cutting edge 40 of the cutting tool 10 can be made to have a higher hardness and greater durability by applying coatings of high hardness materials such as diamond, TiN, and SiC with thickness of up to 0.005 mm, for examples. Accordingly, in one embodiment, the invention is directed to cutting tools in which the in situ composite of bulk-solidifying amorphous alloy blade further includes an ultra-high hardness coating to improve the wear performance.

The aesthetics and color of the cutting tool 10 may be improved by treating the in situ composite of bulk-solidifying amorphous alloy. For example, the cutting tool 10 may be subject to any suitable electrochemical processing, such as anodizing (electrochemical oxidation of the metal). Since such anodic coatings also allow secondary infusions, (i.e., organic and inorganic coloring, lubricity aids, etc.), additional aesthetic or functional processing could be performed on the anodized cutting tools. Any suitable conventional anodizing process may be utilized.

One embodiment of the present invention is directed to a cutting tool 10 in which the thickness and or boundary of the cutting edge 40 varies to form a serration. Such a serration can be formed by any suitable technique, such as in a molding process. This method has the advantage of making the serrations in one step.

The cutting tools of the present invention may include knives, including both fixed and folding knives, scalpels, and the like. The cutting tools may have utility, kitchen, outdoor, surgical and combat uses, for examples. The term “cutting tool” used herein is meant to include any sharp-edged tool that is used for cutting.

The cutting tool 10 made at least in part of an in situ composite of bulk-solidifying amorphous alloy is preferably made by “permanent mold casting,” which, as used herein, includes die casting or any other casting technique having a permanent mold into which metal is introduced, as by pouring, injecting, vacuum drawing, or the like. A composite of bulk-solidifying amorphous alloy in fully molten form is provided. A permanent mold having a mold cavity defining the shape of the part of the cutting tool 10, such as the cutting edge 40 or the whole blade portion 30, is provided. The composite of amorphous alloy is heated to a temperature above liquidus temperature such that it may be introduced into the permanent mold. The molten alloy is cooled to relatively low temperature, such as room temperature, at a rate sufficiently high that the amorphous structure with ductile crystalline precipitates is retained in the final cast product.

A unique characteristic of an in situ composite of bulk-solidifying amorphous alloy, such as that commercially available from Liquidmetal Technologies of Lake Forest, Calif., U.S.A., is the availability of superior mechanical properties in as-cast form. This characteristic allows cutting tool or knife blades of the present invention to be easily fabricated in a single piece using casting and molding techniques. Conventional cutting tools or knife blades are generally cut from sheet metal stock, and after being cut, the edges are ground and sharpened to form the cutting edge.

In situ composite of bulk-solidifying amorphous alloy (or ductile metal reinforced bulk metallic glass matrix composite) has desirable properties such as high elastic strain limit, for example, up to 2%, and high yield strength, for example, up to 1.6 GPa, while providing tensile ductility, for example, up to 10%, and impact toughness, for example several times that of homogenous bulk-solidifying amorphous alloy. The in situ composite material also provides a low modulus of elasticity, in large part due to low modulus of the dendritic phase (which is an extended solid solution of primary phase of the main constituent element). For example, the Young Modulus of Zr-base alloy (e.g., VITRELOY-1™ (hereinafter “V-1”) from Liquidmetal Technologies) can be reduced from about 95 GPa down to 80 GPa in the in situ composite form. As such, this provides a cutting tool blade with good flexibility.

The following describes the details and preparation of methods of in situ composites of bulk-solidifying amorphous alloy. The material exhibits both improved toughness and a large plastic strain to failure. It should be understood that the cutting tool blades of the current invention can be made of these matrix composite materials.

The remarkable glass-forming ability of bulk metallic glasses at low cooling rates (e.g., less than about 103 K/sec) allows for the preparation of ductile metal reinforced composites with a bulk metallic glass matrix via in situ processing; i.e., chemical partitioning. The incorporation of a ductile metal phase into a metallic glass matrix yields a constraint that allows for the generation of multiple shear bands in the metallic glass matrix. This stabilizes crack growth in the matrix and extends the amount of strain to failure of the composite. Specifically, by control of chemical composition and processing conditions, a stable two-phase composite (ductile crystalline metal in a bulk metallic glass matrix) is obtained on cooling from the liquid state.

In order to form a composite amorphous metal object by chemical partitioning, one starts with a composition that may not, by itself, form an amorphous metal upon cooling from the liquid phase at reasonable cooling rates. Instead, the composition includes additional elements or a surplus of some of the components of an alloy that would form a glassy state on cooling from the liquid state.

A particularly attractive bulk glass-forming alloy system is described in U.S. Pat. No. 5,288,344, the disclosure of which is hereby incorporated by reference. For example, to form a composite having a crystalline reinforcing phase and an amorphous matrix, one may start with an alloy in a bulk glass-forming zirconium-titanium-copper-nickel-beryllium system with added niobium. Such a composition is melted so as to be homogeneous. The molten alloy is then cooled to a temperature range between the liquidus and solidus for the composition. This causes chemical partitioning of the composition into solid crystalline ductile metal dendrites and a liquid phase, with different compositions. The liquid phase becomes depleted of the metals crystallizing into the crystalline phase and the composition shifts to one that forms a bulk metallic glass at low cooling rate. Further cooling of the remaining liquid results in formation of an amorphous matrix around the crystalline phase.

Alloys suitable for practice of this invention have a phase diagram with both a liquidus and a solidus that each include at least one portion that is vertical or sloping, i.e., that is not at a constant temperature.

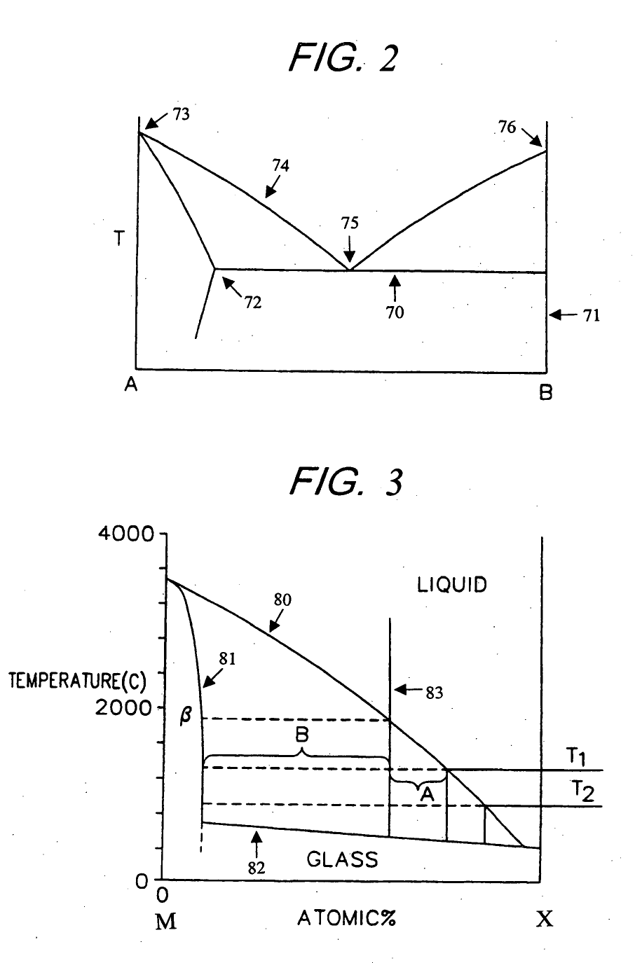

Consider, for example, a binary alloy, AB, having a phase diagram with a eutectic and solid solubility of one metal A in the other metal B as shown in FIG. 2. In such an alloy system the phase diagram has a horizontal or constant temperature solidus line 70 at the eutectic temperature extending from B 71 to a point 72 where B is in equilibrium with a solid solution of B in A. The solidus line 70 then slopes upwardly from the equilibrium point 72 to the melting point of A 73. The liquidus line 74 in the phase diagram extends from the melting point of A 73 to the eutectic composition 75 on the horizontal solidus 70 and from there to the melting point of B 76. Thus, the solidus 70 has a portion that is not at a constant temperature (between the melting point of A 73 and the equilibrium point 72). The vertical line from the melting point of B to the eutectic temperature could also be considered a solidus line where there is no solid solubility of A in B. Likewise, the liquidus 74 has sloping lines that are not at constant temperature. In a ternary alloy phase diagram there are solidus and liquidus surfaces instead of lines.

When referring to the solidus herein, it should be understood that this may not be entirely the same as the solidus in a conventional crystalline metal phase diagram, for example. In usage herein, the solidus refers in part to a line (or surface) defining the boundary between liquid metal and a solid phase. This usage is appropriate when referring to the boundary between the melt and a solid crystalline phase precipitated for forming the phase embedded in the matrix. For the glass-forming remainder of the melt the “solidus” is typically not at a well-defined temperature, but is where the viscosity of the alloy becomes sufficiently high that the alloy is considered to be rigid or solid. Knowing an exact temperature is not important.

Before considering alloy selection, we discuss the partitioning method in a pseudo-binary alloy system. FIG. 3 is a phase diagram for alloys of M and X where X is a good glass-forming composition, i.e., a composition that forms an amorphous metal at reasonable cooling rates. Compositions range from 100% M at the left margin to 100% of the alloy X at the right margin. An upper slightly curved line 80 is a liquidus for M in the alloy and a steeply curving line 81 near the left margin is a solidus for M with some solid solution of components of X in a body centered cubic (bcc) M alloy. A horizontal or near horizontal line 82 below the liquidus is, in effect, a solidus for an amorphous alloy. A vertical line 83 in mid-diagram is an arbitrary alloy where there is an excess of M above a composition that is a good bulk glass-forming alloy.

As one cools the alloy from the liquid, the temperature encounters the liquidus 80. A precipitation of bcc M (with some of the X components, principally titanium and/or zirconium, in solid solution) commences with a composition where a horizontal line from the liquidus encounters the solidus 81. With further cooling, there is dendritic growth of M crystals, depleting the liquid composition of M, so that the melt composition follows along the sloping liquidus line 80. Thus, there is a partitioning of the composition to a solid crystalline bcc, M-rich phase and a liquid composition depleted in M.

At an arbitrary processing temperature T₁ the proportion of solid M alloy corresponds to the distance A and the proportion of liquid remaining corresponds to the distance B in FIG. 3. In other words, about ¼ of the composition is solid dendrites and the other ¾ is liquid. At equilibrium at a second processing temperature T₂ somewhat lower than T₁, there is about ⅓ solid crystalline phase and ⅔ liquid phase.

If one cools the exemplary alloy to the first or higher processing temperature T₁ and holds at that temperature until equilibrium is reached, and then rapidly quenches the alloy, a composite is achieved having about ¼ particles of bcc alloy distributed in a bulk metallic glass matrix having a composition corresponding to the liquidus at T₁. One can vary the proportion of crystalline and amorphous phases by holding the alloy at a selected temperature above the solidus, such as for example, at T₂ to obtain a higher proportion of ductile metallic particles.

Instead of cooling and holding at a temperature to reach equilibrium as represented by the phase diagram, one is more likely to cool from the melt continuously to the solid state. The morphology, proportion, size and spacing of ductile metal dendrites in the amorphous metal matrix is influenced by the cooling rate. Generally speaking, a faster cooling rate provides less time for nucleation and growth of crystalline dendrites, so they are smaller and more widely spaced than for slower cooling rates. The orientation of the dendrites is influenced by the local temperature gradient present during solidification.

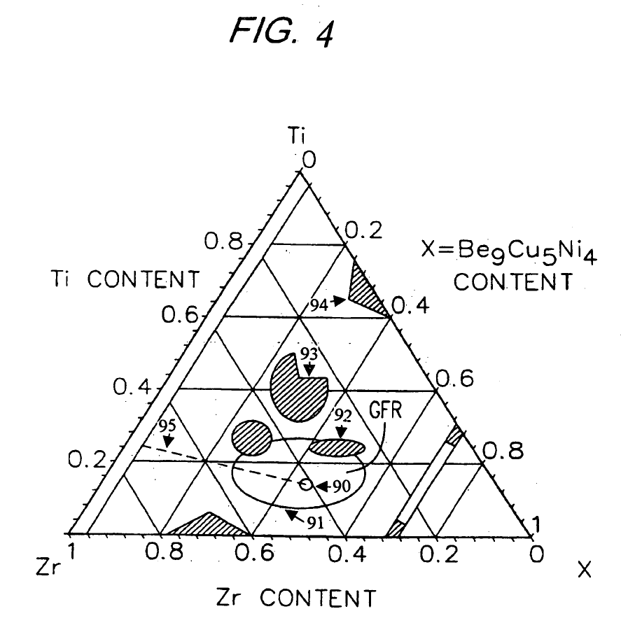

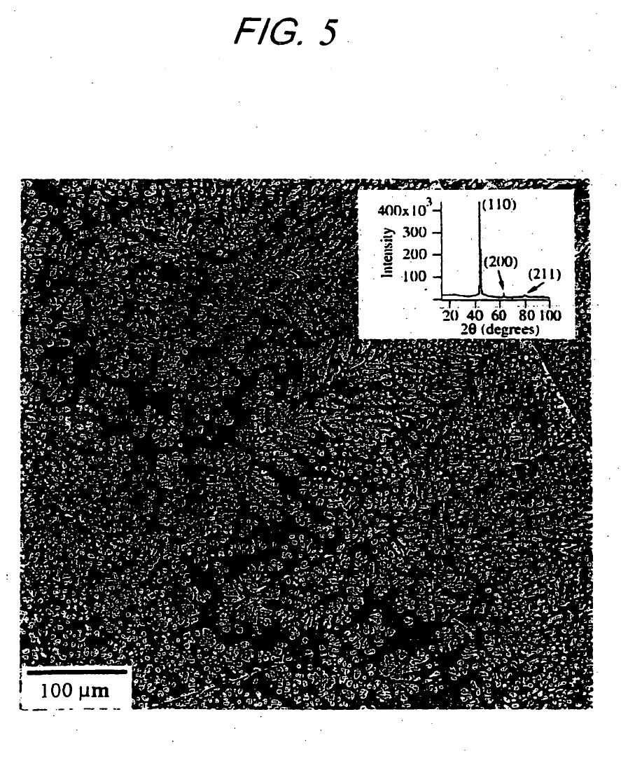

For example, to form a composite with good mechanical properties, and having a crystalline reinforcing phase embedded in an amorphous matrix, one may start with compositions based on bulk metallic glass-forming compositions in the Zr—Ti—M—Cu—Ni—Be system, where M is niobium. Alloy selection can be exemplified by reference to FIG. 4 which is a section of a pseudo-ternary phase diagram with apexes of titanium, zirconium and X, where X is Be₉Cu₅Ni₄.

There are at least two strategies for designing a useful composite of crystalline metal particles distributed in an amorphous matrix in this alloy system. Strategy 1 is based on systematic manipulations of the chemical composition of bulk metallic glass forming compositions in the Zr—Ti—Cu—Ni—Be system. Strategy 2 is based on the preparation of chemical compositions which comprise the mixture of additional pure metal or metal alloys with a good bulk metallic glass-forming composition in the Zr—Ti—Cu—Ni—Be system.

Strategy 1: Systematic Manipulation of Bulk Metallic Glass-Forming Compositions.

An excellent bulk metallic glass-forming composition has been developed with the following chemical composition: (Zr₇₅Ti₂₅)₅₅X₄₅=Zr_{41.2}Ti_{13.8}Cu_{12.5}Ni₁₀Be_{22.5} expressed in atomic percent, and herein labeled as alloy V1. This alloy composition has a proportion of Zr to Ti of 75:25. It is represented on the ternary diagram at the small circle 90 in the large oval 91.

Around the alloy composition V1 lies a large region of chemical compositions which form a bulk metallic glass object (an object having all of its dimensions greater than one millimeter) on cooling from the liquid state at reasonable rates. This bulk glass-forming region (GFR) is defined by the oval labeled 91 and GFR in FIG. 4. When cooled from the liquid state, chemical compositions that lie within this region are fully amorphous when cooled below the glass transition temperature.

The pseudo-ternary diagram shows a number of competing crystalline or quasi-crystalline phases which limit the bulk metallic glass-forming ability. Within the GFR these competing crystalline phases are destabilized, and hence do not prevent the vitrification of the liquid on cooling from the molten state. However, for compositions outside the GFR, on cooling from the high temperature liquid state the molten liquid chemically partitions. If the composition is alloyed properly, it forms a good composite engineering material with a ductile crystalline metal phase in an amorphous matrix. There are compositions outside GFR where alloying is inappropriate and the partitioned composite may have a mixture of brittle crystalline phases embedded in an amorphous matrix. The presence of these brittle crystalline phases seriously degrades the mechanical properties of the composite material formed.

For example, toward the upper right of the larger GFR oval, there is a smaller oval 92 partially overlapping the edge of the larger oval 91, and in this region a brittle Cu₂ZrTi phase may form on cooling the liquid alloy. This is an embrittling phenomenon and such alloys are not suitable for practice of this invention. The regions indicated on this pseudo-ternary diagram are approximate and schematic for illustrating practice of this invention.

Above the left part of large GFR oval 91 as illustrated in FIG. 4 there is a smaller circle 90 representing a region where a quasi-crystalline phase forms, another embrittling phenomenon. An upper partial oval 93 represents another region where a NiTiZr Laves phase forms. A small triangular region 94 along the Zr—X margin represents formation of intermetallic TiZrCu₂ and/or Ti₂Cu phases. Small regions near 70% X are compositions where a ZrBe₂ intermetallic or a TiBe₂ Laves phase forms. Along the Zr—Ti margin a mixture of and Zr or Zr—Ti alloy may be present.

To form a composite with good mechanical properties, a ductile second phase is formed in situ. Thus, the brittle second phases identified in the pseudo-ternary diagram are to be avoided. This leaves a generally triangular region toward the upper left from the Zr₄₂Ti₁₄X₄₄ circle where another metal M may be substituted for some of the zirconium and/or titanium to provide a composite with desirable properties. This is reviewed for a substitution of niobium for some of the titanium.

A dashed line 95 is drawn on FIG. 4 toward the 25% titanium composition on the Zr—Ti margin. In the series of compositions along the dashed line, (Zr₁₀₀₋ₓTi_{x-z}M_{z})_{100-y}((Ni₄₅Cu₅₅))₅₀Be₅₀)_{y} where M=Nb and x=25, increasing z means decreasing the amount of titanium from the original proportion of 75:25. In the portion of the dashed line 95 within the larger oval 91, the compositions are good bulk glass-forming alloys. Once outside the oval 91, ductile dendrites rich in zirconium form in a composite with an amorphous matrix. These ductile dendrites are formed by chemical partitioning over a wide range of z and y values.

For example, when z=3 and y=25, there is formation of phase. It has been shown that phase is formed when z=13.3, extending up to z=20 with y values surrounding 25. Excellent mechanical properties have been found for compositions in the range of z=5 to z=10, with a premier composition where z=about 6.66 along this 75:25 line when M is niobium.

It should be noted that one should not extend along the 75:25 dashed line 95 to less than about 5% beryllium, i.e., where y is less than 10. Below that there is little amorphous phase left and the alloy is mostly dendrites without the desirable properties of the composite.

Consider an alloy series of the form (Zr₁₀₀₁₀₀₋ₓTi_{x-z}M_{z})_{100-y}X_{y} where M is an element that stabilizes the crystalline phase in Ti- or Zr-based alloys and X is defined as before. To form an in situ prepared bulk metallic glass matrix composite material with good mechanical properties it is important that the secondary crystalline phase, preferentially nucleated on cooling from the high temperature liquid, be a ductile second phase. An example of an in situ prepared bulk metallic glass matrix composite which has exhibited outstanding mechanical properties has the nominal composition (Zr₇₅Ti_{18.34}Nb_{6.66})₇₅X₂₅; i.e., an alloy with M=Nb, z=6.66, x=18.34 and y=25. This along the dashed line 95 of alloys in FIG. 4.

Peaks on an x-ray diffraction pattern (inset in SEM photomicrograph of FIG. 5) for this composition show that the secondary phase present has a bcc or phase crystalline symmetry, and that the x-ray pattern peaks are due to the phase only. A Nelson-Riley extrapolation yields a phase lattice parameter a=3.496 Angstroms. Thus, upon cooling from the high temperature melt, the alloy undergoes partial crystallization by nucleation and subsequent dendritic growth of the ductile crystalline metal phase in the remaining liquid. The remaining liquid subsequently freezes to the glassy state producing a two-phase microstructure containing phase dendrites in an amorphous matrix. The final microstructure of a chemically etched specimen is shown in the SEM image of FIG. 5.

SEM electron microprobe analysis gives the average composition for the phase dendrites (light phase in FIG. 5) to be Zr₇₁Ti_{16.3}Nb₁₀Cu_{1.8}Ni_{0.9}. Under the assumption that all of the beryllium in the alloy is partitioned into the matrix, we estimate that the average composition of the amorphous matrix (dark phase) is Zr₄₇Ti_{12.9}Nb_{2.8}Cu₁₁Ni_{9.6}Be_{16.7}. Microprobe analysis also shows that within experimental error (about ±1 at. %), the compositions within the two phases do not vary. This implies complete solute redistribution and the establishment of chemical equilibrium within and between the phases.

Differential scanning calorimetry analysis of the heat of crystallization of the remaining amorphous matrix compared with that of the fully amorphous sample gives a direct estimate of the molar fractions (and volume fractions) of the two phases. This gives an estimated fraction of about 25% phase by volume and about 75% amorphous phase. Direct estimates based on area analysis of the SEM image agree well with this estimate. The SEM image of FIG. 5 shows the fully developed dendritic structure of the phase. The dendritic structures are characterized by primary dendrite axes with lengths of 50-150 micrometers and radius of about 1.5-2 micrometers. Regular patterns of secondary dendrite arms with spacing of about 6-7 micrometers are observed, having radii somewhat smaller than the primary axis. The dendrite “trees” have a very uniform and regular structure. The primary axes show some evidence of texturing over the sample as expected since dendritic growth tends to occur in the direction of the local temperature gradient during solidification.

The relative volume proportion of the phase present in the in situ composite can be varied greatly by control of the chemical composition and the processing conditions. For example, by varying the y value in the alloy series along the dashed line in FIG. 4, (Zr₇₅Ti_{18.34}Nb_{6.66})_{100-y}X_{y}, with M=Nb; i.e., by varying the relative proportion of the early- and late-transition metal constituents; the resultant microstructure and mechanical behavior exhibited on mechanical loading changes dramatically. In situ composites in the Zr—Ti—M—Cu—Ni—Be system have been prepared for alloy series other than the series along the dashed line. These additional alloy series sweep out a region of the quinary composition phase space shown in FIG. 4. The region sweeps in a clockwise direction from a line (not shown) from the V1 alloy composition to the Zr apex of the pseudo-ternary diagram through the dashed line, and extending through to a line (not shown) from the V1 alloy to the Ti apex of the pseudo-ternary diagram, but excluding those regions where a brittle crystalline, quasi-crystalline or Laves phase is stable.

Strategy 2: The Preparation of In Situ Composites by the Mixture of Pure Metal or Metal Alloys with Bulk Metallic Glass-Forming Compositions.

As an additional example of the design of in situ composites by chemical partitioning, we discuss the following series of materials. These alloys are prepared by rule of mixture combinations of a metal or metal alloy with a good bulk metallic glass (BMG) forming composition. The formula for such a mixture is given by BMG(100-x)+M(x) or BMG(100-x)+Nb(x), where M=Nb. Preferably, in situ composite alloys of this form are prepared by first melting the metal or metallic alloy with the early transition metal constituents of the BMG composition. Thus, pure Nb metal is mixed via arc melting with the Zr and Ti of the V1 alloy. This mixture is then arc melted with the remaining constituents; i.e., Cu, Ni, and Be, of the V1 BMG alloy. This molten mixture, upon cooling from the high temperature melt, undergoes partial crystallization by nucleation and subsequent dendritic growth of nearly pure Nb dendrites, with phase symmetry, in the remaining liquid. The remaining liquid subsequently freezes to the glassy state producing a two-phase microstructure containing Nb rich beta phase dendrites in an amorphous matrix.

If one starts with an alloy composition-with an excess of approximately 25 atomic % niobium above a preferred composition (Zr_{41.2}Ti_{13.8}Cu_{12.4}Ni_{10.1}Be_{22.5}) for forming a bulk metallic glass, ductile niobium alloy crystals are formed in an amorphous matrix upon cooling a melt through the region between the liquidus and solidus. The composition of the dendrites is about 82% (atomic %) niobium, about 8% titanium, about 8.5% zirconium, and about 1.5% copper plus nickel. This is the composition found when the proportion of dendrites is about ¼ bcc phase and ¾ amorphous matrix. Similar behaviors are observed when tantalum is the additional metal added to what would otherwise be a V1 alloy. Besides niobium and tantalum, suitable additional metals which may be in the composition for in situ formation of a composite may include molybdenum, chromium, tungsten and vanadium.

The proportion of ductile bcc-forming elements in the composition can vary widely. Composites of crystalline bcc alloy particles distributed in a nominally V1 matrix have been prepared with about 75% V1 plus 25% Nb, 67% V1 plus 33% Nb (all percentages being atomic). The dendritic particles of bcc alloy form by chemical partitioning from the melt, leaving a good glass-forming alloy for forming a bulk metallic glass matrix.

Partitioning may be used to obtain a small proportion of dendrites in a large proportion of amorphous matrix all the way to a large proportion of dendrites in a small proportion of amorphous matrix. The proportions are readily obtained by varying the amount of metal added to stabilize a crystalline phase. By adding a large proportion of niobium, for example, and reducing the sum of other elements that make a good bulk metallic glass-forming alloy, a large proportion of crystalline particles can be formed in a glassy matrix.

It appears to be important to provide a two-phase composite and avoid formation of a third phase. It is clearly important to avoid formation of a third brittle phase, such as an intermetallic compound, Laves phase or quasi-crystalline phase, since such brittle phases significantly degrade the mechanical properties of the composite.

It may be feasible to form a good composite as described herein, with a third phase or brittle phase having a particle size significantly less than 0.1 micrometers. Such small particles may have minimal effect on formation of shear bands and little effect on mechanical properties.

In the niobium enriched Zr—Ti—Cu—Ni—Be system, the microstructure resulting from dendrite formation from a melt comprises a stable crystalline Zr—Ti—Nb alloy, with beta phase (bcc) structure, in a Zr—Ti—Nb—Cu—Ni—Be amorphous metal matrix. These ductile crystalline metal particles distributed in the amorphous metal matrix impose intrinsic geometrical constraints on the matrix that leads to the generation of multiple shear bands under mechanical loading.

Sub-standard size Charpy specimens were prepared from a new in situ-formed composite material having a total nominal alloy composition of Zr_{56.25}Nb₅Ti_{13.76}CU_{6.875}Ni_{5.625}Be_{12.5}. These have demonstrated Charpy impact toughness numbers that are 250% greater than that of the bulk metallic glass matrix alone; 15 ft-lb. vs. 6 ft-lb. Bend tests have shown large plastic strain to failure values of about 4%. The multiple shear band structures generated during these bend tests have a periodicity of spacing equal to about 8 micrometers, and this periodicity is determined by the phase dendrite morphology and spacing. In some cast plates with a faster cooling rate, plastic strain to failure in bending has been found to be about 25%. Samples have been found that will sustain a 180° bend.

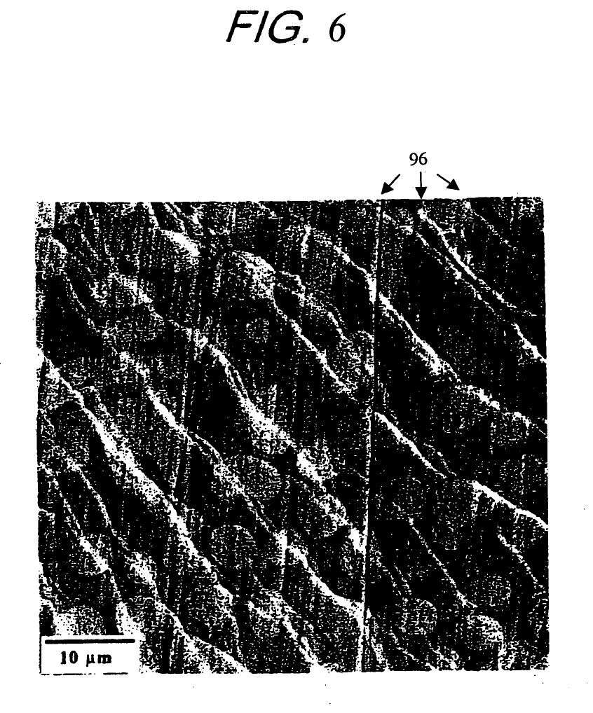

In a specimen after straining, as shown in FIG. 6, shear bands 96 can be seen traversing both the amorphous metal matrix phase and the ductile metal dendrite phase. The directions of the shear bands 96 differ slightly in the two phases due to different mechanical properties and probably because of crystal orientation in the dendritic phase.

Shear band patterns as described occur over a wide range of strain rates. A specimen showing shear bands crossing the matrix and dendrites was tested under quasi-static loading with strain rates of about 10⁻⁴ to 10⁻³ per second. Dramatically improved Charpy impact toughness values show that this mechanism is operating at strain rates of 10⁻³ per second, or higher.

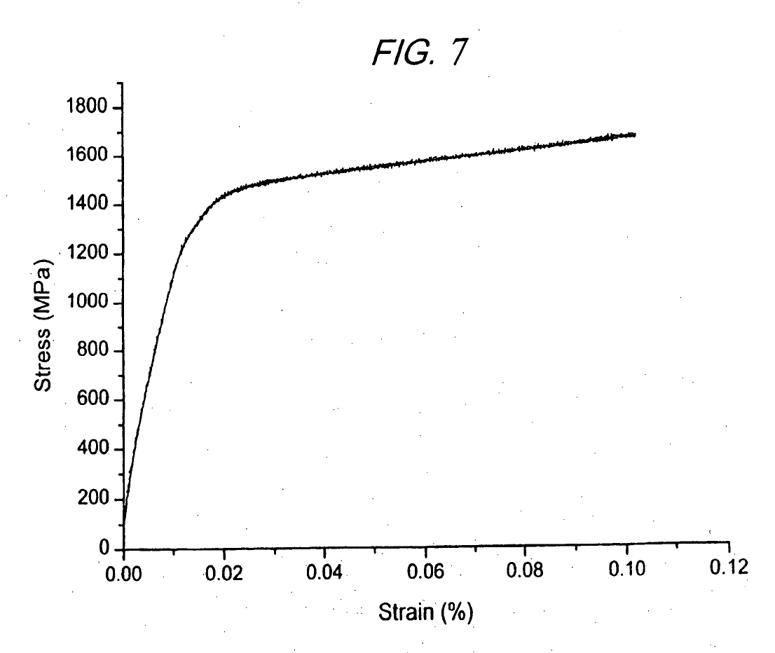

Specimens tested under compressive loading exhibit large plastic strains to failure on the order of 8%. An exemplary compressive stress-strain curve as shown in FIG. 7, exhibits an elastic-perfectly-plastic compressive response with plastic deformation initiating at an elastic strain of about 0.01. Beyond the elastic limit the stress-strain curve exhibits a slope implying the presence of significant work hardening. This behavior is not observed in bulk metallic glasses, which normally show strain-softening behavior beyond the elastic limit. These tests were conducted with the specimens unconfined, where monolithic amorphous metal would fail catastrophically. In these compression tests, failure occurred on a plane oriented at about 45° from the loading axis. This behavior is similar to the failure mode of the bulk metallic glass matrix. Plates made with faster cooling rates and smaller dendrite sizes have been shown to fail at about 20% strain when tested in tension.

One may also design good bulk glass-forming alloys with high titanium content as compared with the high zirconium content alloys described above. Thus, for example, in the Zr—Ti—M—Ni—Cu—Be alloy system a suitable glass-forming composition comprises (Zr₁₀₀₋ₓTi_{x-z}M_{z})_{100-y}((Ni₄₅Cu₅₅))₅₀Be₅₀)_{y} where x is in the range of from 5 to 95, y is in the range of from 10 to 30, z is in the range of from 3 to 20, and M is selected from the group consisting of niobium, tantalum, tungsten, molybdenum, chromium and vanadium. Amounts of other elements or excesses of these elements may be added for partitioning from the melt to form a ductile second phase embedded in an amorphous matrix.

Experimental results indicate that the beta phase morphology and spacing may be controlled by chemical composition and/or processing conditions. This in turn may yield significant improvements in the properties observed; e.g., fracture toughness and high-cycle fatigue. These results offer a substantial improvement over the presently existing bulk metallic glass materials.

Earlier ductile metal-reinforced bulk metallic glass matrix composite materials have not shown large improvements in the Charpy numbers or large plastic strains to failure. This is due at least in part to the size and distribution of the secondary particles mechanically introduced into the bulk metallic glass matrix. The substantial improvements observed in the new in situ-formed composite materials are manifest by the dendritic morphology, particle size, particle spacing, periodicity and volumetric proportion of the ductile beta phase. This dendrite distribution leads to a confinement geometry that allows for the generation of a large shear band density, which in turn yields a large plastic strain within the material.

Another factor in the improved behavior is the quality of the interface between the ductile metal beta phase and the bulk metallic glass matrix. In the new composites this interface is chemically homogeneous, atomically sharp and free of any third phases. In other words, the materials on each side of the boundary are in chemical equilibrium due to formation of dendrites by chemical partitioning from a melt. This clean interface allows for an iso-strain boundary condition at the particle-matrix interface; this allows for stable deformation and for the propagation of shear bands through the beta phase particles.

Thus, it is desirable to form a composite in which the ductile metal phase included in the glassy matrix has a stress induced martensite transformation. The stress level for transformation induced plasticity, either martensite transformation or twinning, of the ductile metal particles is at or below the shear strength of the amorphous metal phase.

The ductile particles preferably have face centered cubic (fcc), bcc or hexagonal close-packed (hcp) crystal structures, and in any of these crystal structures there are compositions that exhibit stress-induced plasticity, although not all fcc, bcc or hcp structures exhibit this phenomenon. Other crystal structures may be too brittle or transform to brittle structures that are not suitable for reinforcing an amorphous metal matrix composite.

This new concept of chemical partitioning is believed to be a global phenomenon in a number of bulk metallic glass-forming systems; i.e., in composites that contain a ductile metal phase within a bulk metallic glass matrix, that are formed by in situ processing. For example, similar improvements in mechanical behavior may be observed in (Zr₁₀₀₋ₓTi_{x-z}M_{z})₁₀₀₋ₓ(X)_{y} materials, where X is a combination of late transition metal elements that leads to the formation of a bulk metallic glass; in these alloys X does not include Be.

It is important that the crystalline phase be a ductile phase to support shear band deformation through the crystalline phase. If the second phase in the amorphous matrix is an intrinsically brittle ordered intermetallic compound or a Laves phase, for example, there is little ductility produced in the composite material. Ductile deformation of the particles is important for initiating and propagating shear bands. It may be noted that ductile materials in the particles may work harden, and such work hardening can be mitigated by annealing, although it is important not to exceed a glass transition temperature that would lose the amorphous phase.

The particle size of the dendrites of crystalline phase can also be controlled during the partitioning. If one cools slowly through the region between the liquidus and processing temperature, few nucleation sites occur in the melt and relatively larger particle sizes can be formed. On the other hand, if one cools rapidly from a completely molten state above the liquidus to a processing temperature and then holds at the processing temperature to reach near equilibrium, a larger number of nucleation sites may occur, resulting in smaller particle size.

The particle size and spacing between particles in the solid phase may be controlled by cooling rate between the liquidus and solidus, and/or time of holding at a processing temperature in this region. This may be a short interval to inhibit excessive crystalline growth. The addition of elements that are partitioned into the crystalline phase may also assist in controlling particle size of the crystalline phase. For example, addition of more niobium apparently creates additional nucleation sites and produces finer grain size. This can leave the volume fraction of the amorphous phase substantially unchanged and simply change the particle size and spacing. On the other hand, a change in temperature between the liquidus and solidus from which the alloy is quenched can control the volume fraction of crystalline and amorphous phases. A volume fraction of ductile crystalline phase of about 25% appears near optimum.

In one example, the solid phase formed from the melt may have a composition in the range of from 67 to 74 atomic percent zirconium, 15 to 17 atomic percent titanium, 1 to 3 atomic percent copper, 0 to 2 atomic percent nickel, and 8 to 12 atomic percent niobium. Such a composition is crystalline, and would not form an amorphous alloy at reasonable cooling rates.

The remaining liquid phase has a composition in the range of from 35 to 43 atomic percent zirconium, 9 to 12 atomic percent titanium, 7 to 11 atomic percent copper, 6 to 9 atomic percent nickel, 28 to 38 atomic percent beryllium, and 2 to 4 atomic percent niobium. Such a composition falls within a range that forms amorphous alloys upon sufficiently rapid cooling.

Upon cooling through the region between the liquidus and solidus at a rate estimated at less than 50 K/sec, ductile dendrites are formed with primary lengths of about 50 to 150 micrometers. (Cooling was from one face of a one centimeter thick body in a water cooled copper crucible.) The dendrites have well-developed secondary arms in the order of four to six micrometers wide, with the secondary arm spacing being about six to eight micrometers. It has been observed in compression tests of such material that shear bands are equally spaced at about seven micrometers. Thus, the shear band spacing is coherent with the secondary arm spacing of the dendrites.

In other castings with cooling rates significantly greater, probably at least 100 K/sec, the dendrites are appreciably smaller, about five micrometers along the principal direction and with secondary arms spaced about one to two micrometers apart. The dendrites have more of a snowflake-like appearance than the more usual tree-like appearance. Dendrites seem less uniformly distributed and occupy less of the total volume of the composite (about 20%) than in the more slowly cooled composite. (Cooling was from both faces of a body 3.3 mm thick.) In such a composite, the shear bands are more dense than in the composite with larger and more widely spaced dendrites. It is estimated that in the first composite about four to five percent of the volume is in shear bands, whereas in the “finer grained” composite the shear bands are from two to five times as dense. This means that there is a greater amount of deformed metal, and this is also shown by the higher strain to failure in the second composite.

As used herein, when speaking of particle size or particle spacing, the intent is to refer to the width and spacing of the secondary arms of the dendrites, when present. In absence of a dendritic structure, particle size would have its usual meaning, i.e., for round or nearly round particles, an average diameter. It is also possible that acicular or lamellar ductile metal structures may be formed in an amorphous matrix. Width of such structures is considered as particle size. It will also be noted that the secondary arms in a dendritic are not uniform width; they taper from a wider end adjacent the principal axis toward a pointed or slightly rounded free end. Thus, the “width” is some value between the ends in a region where shear bands propagate. Similarly, since the arms are wider at the base, the spacing between arms narrows at that end and widens toward the tips. Shear bands seem to propagate preferentially through regions where the width and spacing are about the same magnitude. The dendrites are, of course, three-dimensional structures and the shear bands are more or less planar, so this is only an approximation.

When referring to particle spacing, the center-to-center spacing is intended, even if the text may inadvertently refer to the spacing in a context that suggests edge-to-edge spacing.

One may also control particle size by providing artificial nucleation sites distributed in the melt. These may be minute ceramic particles of appropriate crystal structure or other materials insoluble in the melt. Agitation may also be employed to affect nucleation and dendrite growth. Cooling rate techniques are preferred since repeatable and readily controlled.

It appears that the improved mechanical properties can be obtained from such a composite material where the second ductile metal phase embedded in the amorphous metal matrix, has a particle size in the range of from about 0.1 to 15 micrometers. If the particles are smaller than 100 nanometers, shear bands may effectively avoid the particles and there is little if any effect on the mechanical properties. If the particles are too large, the ductile phase effectively predominates and the desirable properties of the amorphous matrix are diluted. Preferably, the particle size is in the range of from 0.5 to 8 micrometers since the best mechanical properties are obtained in that size range. The particles of crystalline phase should not be too small or they are smaller than the width of the shear bands and become relatively ineffective. Preferably, the particles are slightly larger than the shear band spacing.

The spacing between adjacent particles are preferably in the range of from 0.1 to 20 micrometers. Such spacing of a ductile metal reinforcement in the continuous amorphous matrix induces a uniform distribution of shear bands throughout a deformed volume of the composite, with strain rates in the range of from about 10⁻⁴ to 10⁻³ per second. Preferably, the spacing between particles is in the range of from 1 to 10 micrometers for the best mechanical properties in the composite.

The volumetric proportion of the ductile metal particles in the amorphous matrix is also significant. The ductile particles are preferably in the range of from 5 to 50 volume percent of the composite, and most preferably in the range of from 15 to 35% for the best improvements in mechanical properties. When the proportion of ductile crystalline metal phase is low, the effects on properties are minimal and little improvement over the properties of the amorphous metal phase may be found. On the other hand, when the proportion of the second phase is large, its properties dominate and the valuable assets of the amorphous phase are unduly diminished.

There are circumstances, however, when the volumetric proportion of amorphous metal phase may be less than 50% and the matrix may become a discontinuous phase. Stress induced transformation of a large proportion of in situ-formed crystalline metal modulated by presence of a smaller proportion of amorphous metal may provide desirable mechanical properties in a composite.

The size of and spacing between the particles of ductile crystalline metal phase preferably produces a uniform distribution of shear bands having a width of the shear bands in the range of from about 100 to 500 nanometers. Typically, the shear bands involve at least about four volume percent of the composite material before the composite fails in strain. Small spacing is desirable between shear bands since ductility correlates to the volume of material within the shear bands. Thus, it is preferred that there be a spacing between shear bands when the material is strained to failure in the range of from about 1 to 10 micrometers. If the spacing between bands is less than about ½ micrometer or greater than about 20 micrometers, there is little toughening effect due to the particles. The spacing between bands is preferably about two to five times the width of the bands. Spacing of as much as 20 times the width of the shear bands can produce engineering materials with adequate ductility and toughness for many applications.

In one example, when the band density is about 4% of the volume of the material, the energy of deformation before failure is estimated to be in the order of 23 joules (with a strain rate of about 10² to 10³/sec in a Charpy-type test). Based on such estimates, if the shear band density were increased to 30 volume percent of the material, the energy of deformation rises to about 120 joules.

For alloys usable for making objects with dimensions larger than micrometers, cooling rates from the region between the liquidus and solidus of less than 1000 K/sec are desirable. Preferably, cooling rates to avoid crystallization of the glass-forming alloy are in the range of from 1 to 100 K/sec or lower. For identifying acceptable glass-forming alloys, the ability to form layers at least 1 millimeter thick has been selected. In other words, an object having an amorphous metal alloy matrix has a thickness of at least one millimeter in its smallest dimension.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. A cutting tool comprising:
a blade portion having a cutting edge; and
a body portion;
wherein at least one of the blade portion or the body portion are formed at least in part of a composite material comprising: an amorphous metal alloy forming a substantially continuous matrix; and a second ductile metal phase embedded in the matrix and formed in situ in the matrix by crystallization from a molten alloy.

2. The cutting tool of claim 1, wherein the second phase is formed from a molten alloy having an original composition in the range of from 52 to 68 atomic percent zirconium, 3 to 17 percent titanium, 2.5 to 8.5 atomic percent copper, 2 to 7 atomic percent nickel, 5 to 15 percent beryllium, and 3 to 20 percent niobium.

3. The cutting tool of claim 1, wherein the second phase is sufficiently spaced apart for inducing a uniform distribution of shear bands throughout a deformed volume of the composite, the shear bands involving at least four volume percent of the composite before failure in strain and traversing both the amorphous metal alloy matrix and the second phase.

4. The cutting tool of claim 3, wherein the second phase is in the form of dendrites.

5. The cutting tool of claim 3, wherein the second phase has a modulus of elasticity less than the modulus of elasticity of the amorphous metal alloy.

6. The cutting tool of claim 3, wherein the ductile metal particles of the second phase are sufficiently spaced apart for inducing a uniform distribution of shear bands traversing both the amorphous phase and the second phase and having a width of each shear band in the range of from 100 to 500 nanometers.

7. The cutting tool of claim 3, wherein the second phase has an interface in chemical equilibrium with the amorphous metal alloy matrix.

8. The cutting tool of claim 3, wherein a stress level for transformation induced plasticity of the ductile metal particles is at or below a shear strength of the amorphous metal alloy matrix.

9. The cutting tool of claim 1, wherein the second phase comprises particles having a spacing between adjacent particles in the range of 0.1 to 20 micrometers.

10. The cutting tool of claim 1, wherein the second phase comprises particles having a particle size in the range of from 0.1 to 15 micrometers.

11. The cutting tool of claim 1, wherein the second phase comprises in the range of from 15 to 35 volume percent of the composite.

12. The cutting tool of claim 1, further comprising a handle mounted onto the body portion

13. The cutting tool of claim 12, wherein the handle is formed from a material selected from the group consisting of: a plastic, a metal and wood.

14. The cutting tool of claim 1, wherein the cutting edge is serrated.

15. The cutting tool of claim 1, wherein the cutting edge has a radius of curvature of about 150 Angstroms or less.

16. The cutting tool of claim 1, wherein the composite material has a thickness of at least 1 mm.

17. The cutting tool of claim 1, wherein the second phase comprising a ductile metal alloy has an interface in chemical equilibrium with the amorphous metal matrix, and the composite is free of a third phase.

18. The cutting tool of claim 1, wherein the composite has a stress induced martensitic transformation.

19. A cutting tool comprising:
a blade portion having a cutting edge; and
a body portion;
wherein at least one of the blade portion or the body portion are formed at least in part of a composite material comprising: an amorphous metal alloy forming a substantially continuous matrix; a second ductile metal phase in the form of dendrites is embedded in the matrix and formed in situ in the matrix by crystallization from a molten alloy; and
wherein the dendrites have lengths of about 15 to 150 micrometers, the dendrites comprise secondary arms having widths of about 4 to 6 micrometers, and the secondary arms are spaced apart about 6 to 8 micrometers.

20. A cutting tool comprising:
a blade portion having a cutting edge; and
a body portion;
wherein at least one of the blade portion or the body portion are formed at least in part of a composite material comprising: an amorphous metal alloy forming a substantially continuous matrix; and a second ductile metal phase in the form of particles is embedded in the matrix and formed in situ in the matrix by crystallization from a molten alloy; and
wherein the particles have a particle size in the range of from 0.1 to 15 micrometers, spacing between adjacent particles in the range of 0.1 to 20 micrometers, the particles are in the range of from about 5 to 50 volume percent of the composite, the particles are sufficiently spaced apart for inducing a uniform distribution of shear bands traversing both the amorphous phase and the second phase and having a width of each shear band in the range of from 100 to 500 nanometers.
